(19) United States
(12) Patent Application Publication
(10) Pub. No.: US 2004/0064655 A1
(43) Pub. Date: Apr. 1, 2004

(54) Memory access statistics tool

(76) Inventor: Dominic Paulraj, Sunnyvale, CA (US)

Correspondence Address: HAMILTON & TERRILE, LLP, P.O. BOX 203518, AUSTIN, TX, 78720, US

(21) Appl. No.: 10/256,337

(22) Filed: Sep. 27, 2002

(51) Int. Cl. G06F 12/00

(52) U.S. Cl. 711/154; 711/210; 711/207

(57) ABSTRACT

A method of generating physical memory access statistics for a computer system having a non-uniform memory access architecture which includes a plurality of processors located on a respective plurality of boards. The method includes monitoring when a memory trap occurs, determining a physical memory access location when the memory trap occurs, determining a frequency of physical memory accesses by the plurality of processors based upon the physical memory access locations, and generating physical memory statistics showing the frequency of physical memory accesses by the plurality of processors for each board of the computer system.

### BACKGROUND OF THE INVENTION

1. Field of the Invention

The present invention relates to determining physical memory access statistics for a computer system and more particularly to determining non-uniform memory access statistics for a computer system.

2. Description of the Related Art

Many server type computer systems have non-uniform memory access (NUMA) features. NUMA is a multiprocessing architecture in which memory is separated into local and remote memory. Local memory is the memory that is resident on memory modules on a board on which the processor also resides. Remote memory is the memory that is resident in memory modules that reside on a board other than the board on which the processor resides. In a NUMA system, memory on the same processor board as the CPU (the local memory) is accessed by the CPU faster than memory on other processor boards (the remote memory) is accessed by the CPU, hence the term non-uniform nomenclature. A cache coherent NUMA system is a NUMA system in which caching is supported in the local system.

Memory access latency varies dramatically between access to local memory and access to remote memory. Application performance also varies depending on the way that virtual memory is mapped to physical pages.

Prior to the Solaris 9 operating system, physical page placement on boards was unrelated to the locality of the referencing process or thread. A new version of the Solaris operating system provides a feature of having a NUMA aware kernel. The NUMA aware kernel tries to map a physical page onto the physical memory of the local board where a thread is executing using a first touch placement policy. A first touch placement policy allocates the memory based upon the board location of the first access of the processor.

In known NUMA systems, it is difficult to determine during run time, the frequency of access to various memory boards. Because memory latency varies between access to local boards and access to remote boards, it is desirable to determine the frequency of access to various memory boards.

### SUMMARY OF THE INVENTION

In accordance with the present invention, a tool is provided which allows determining during run time, the frequency of access to various memory boards. The tool provides an output indicating the frequency of memory accesses targeted to a specific memory board from each CPU.

In one embodiment, the invention relates to a method of generating physical memory access statistics for a computer system having a non-uniform memory access architecture which includes a plurality of processors located on a respective plurality of boards. The method includes monitoring when a memory trap occurs, determining a physical memory access location when the memory trap occurs, determining a frequency of physical memory accesses by the plurality of processors based upon the physical memory access locations, and generating physical memory statistics showing the frequency of physical memory accesses by the plurality of processors for each board of the computer system.

In another embodiment, the invention relates to a tool for generating physical memory access statistics for a computer system having a non-uniform memory access architecture, the computer system includes a plurality of processors located on a respective plurality of boards. The tool includes a user command portion and a device driver portion. The user command portion allows a user to access the tool and includes means for presenting the physical memory access statistics. The device driver portion includes means for monitoring when a memory trap occurs, means for determining a physical memory access location when the memory trap occurs, means for determining a frequency of physical memory accesses by the plurality of processors based upon the physical memory access locations, and means for generating physical memory statistics showing the frequency of physical memory accesses by the plurality of processors for each board of the computer system.

In another embodiment, the invention relates to an apparatus for generating physical memory access statistics for a computer system having a non-uniform memory access architecture. The computer system includes a plurality of processors located on a respective plurality of boards. The apparatus includes a user command portion and a device driver portion. The user command portion allows a user to access the tool and includes instructions for presenting the physical memory access statistics, and instructions for monitoring when a memory trap occurs. The device driver portion includes instructions for determining a physical memory access location when the memory trap occurs, instructions for determining a frequency of physical memory accesses by the plurality of processors based upon the physical memory access locations; and instructions for generating physical memory statistics showing the frequency of physical memory accesses by the plurality of processors for each board of the computer system.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element. Also, elements referred to with a particular reference number followed by a letter may be collectively referenced by the reference number alone.

FIG. 1 shows a block diagram of a multiprocessing computer system.

FIG. 2 shows a block diagram of the interaction of a memory access statistics tool and the computer system.

FIG. 3 shows a flow chart of the operation of a memory access statistics tool in accordance with the present invention.

FIG. 4 shows a more detailed flow chart of the operation of memory access statistics tool.

FIG. 5 shows a flow chart of a method for determining a physical address.

FIG. 6 shows a flow chart of a method for determining a board number.

### DETAILED DESCRIPTION

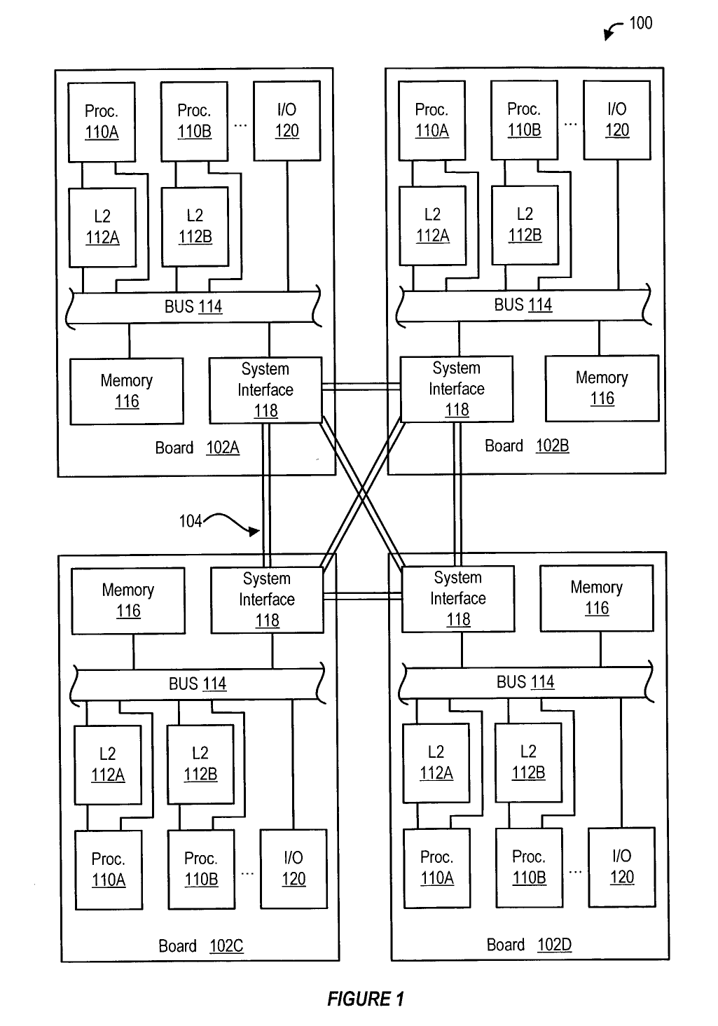

Referring to FIG. 1, a block diagram of an example multiprocessing computer system 100 is shown. The computer system 100 includes multiple boards (also referred to as nodes) 102A-102D interconnected via a point to point network 104. Each board 102 includes multiple processors 110A and 110B, caches 112A and 112B, a bus 114, a memory 116, a system interface 118 and an I/O interface 120. The processors 110A and 110B are coupled to caches 112A and 112B respectively, which are coupled to the bus 114. Processors 110A and 110B are also directly coupled to the bus 114. The memory 116, the system interface 118 and the I/O interface 120 are also coupled to the bus 114. The I/O interface 120 interfaces with peripheral devices such as serial and parallel ports, disk drives, modems, printers, etc. Other boards 102 may be configured similarly.

Computer system 100 is optimized for minimizing network traffic and for enhancing overall performance. The system interface 118 of each board 102 may be configured to prioritize the servicing of read to own (RTO) transaction requests received via the network 104 before the servicing of certain read to share (RTS) transaction request, even if the RTO transaction requests are received by the system interface 118 after the RTS transaction request. In one implementation, such a prioritization is accomplished by providing a queue within the system interface 118 for receiving RTO transaction request which is separate from a second queue for receiving RTS transaction request. In such an implementation, the system interface 118 is configured to service a pending RTO transaction request within the RTO queue before servicing certain earlier received, pending RTS transaction requests in the second queue.

A memory operation is an operation causing transfer of data from a source to a destination. The source and destination may be storage locations within the initiator or may be storage locations within the memory. When a source or destination is a storage location within memory, the source or destination is specified via an address conveyed with the memory operation. Memory operations may be read or write operations (i.e., load or store operations). A read operation causes transfer of data from a source outside of the initiator to a destination within the initiator. A write operation causes transfer of data from a source within the initiator to a destination outside of the initiator. In the computer system 100, a memory operation may include one or more transactions upon bus 114 as well as one or more operations conducted via network 104.

Each board 102 is essentially a system having memory 116 as shared memory. The processors 110 are high performance processors. In one embodiment, each processor 110 is available from Sun Microsystems as a SPARC processor compliant with version 9 of the SPARC processor architecture. Any processor architecture may be employed by processors 110.

Processors 110 include internal instruction and data caches. Thus caches 112 are referred to as external caches and may be considered L2 caches. The designation L2 corresponds to level 2, where the level 1 cache is internal to the processor 110. If the processors 110 are not configured with internal caches, then the caches 112 would be level 1 caches. The level nomenclature identifies proximity of a particular cache to the processing core within processor 110. Caches 112 provide rapid access to memory addresses frequently accessed by a respective processor 110. The caches 112 may be configured in any of a variety of specific cache arrangements such as, for example, set associative or direct mapped configurations.

The memory 116 is configured to store data and instructions for use by the processors 110. The memory 116 is preferably a dynamic random access memory (DRAM) although any type of memory may be used. Each memory 116 includes a corresponding memory management unit (MMU) and translation lookaside buffer (TLB). The memory 116 of each board 102 combines to provide a shared memory system. Each address in the address space of the distributed shared memory is assigned to a particular board, referred to as the home board of the address. A processor within a different board than the home board may access the data at an address of the home board, potentially caching the data. Coherency is maintained between boards 102 as well as among processors 110 and caches 112. The system interface 118 provides interboard coherency as well as intraboard coherency of the memory 116.

In addition to maintaining interboard coherency, system interface 118 detects addresses upon the bus 114 which require a data transfer to or from another board 102. The system interface performs the transfer and provides the corresponding data for the transaction upon the bus 114. In one embodiment, the system interface 118 is coupled to a point to point network. However, in alternative embodiments other networks may be used. In a point to point network individual connections exist between each board of the network. A particular board communicates directly with a second board via a dedicated link. To communicate with a third board, the particular board uses a different link than the one used to communicate with the second board.

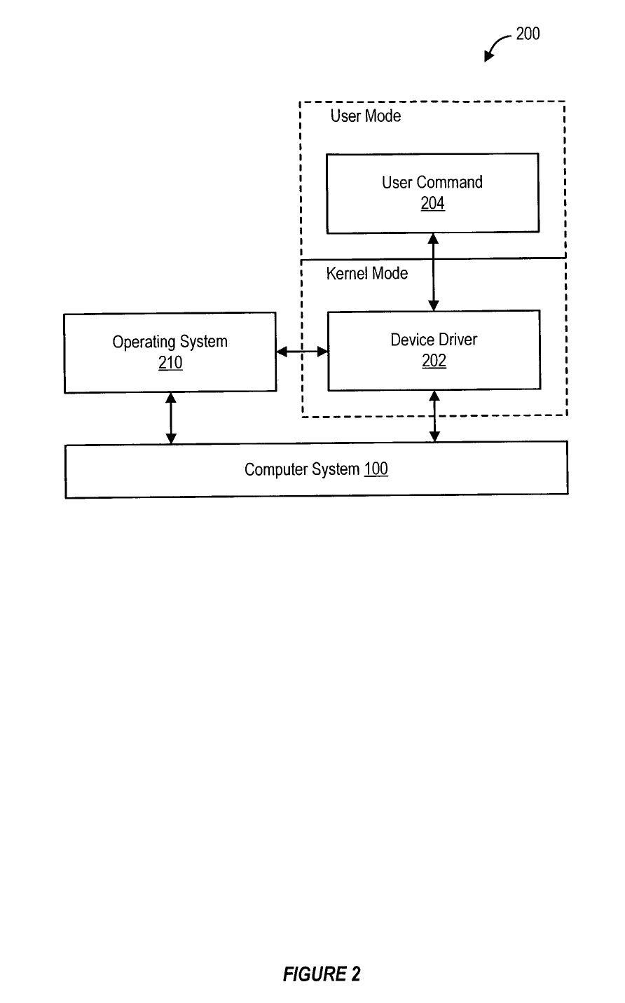

Referring to FIG. 2, a block diagram of a software stack of the memory access statistics tool 200 is shown. The memory access statistics tool 200 includes a device driver module 202 and a user command module 204. The device driver module 202 interacts with the operating system 210. The device driver module 202 and the operating system 210 interact with and are executed by the computer system 100. The device driver module 202 executes at a supervisor (i.e., a kernel) level. The user command module 204 may be accessed by any user wishing to generate memory access statistics.

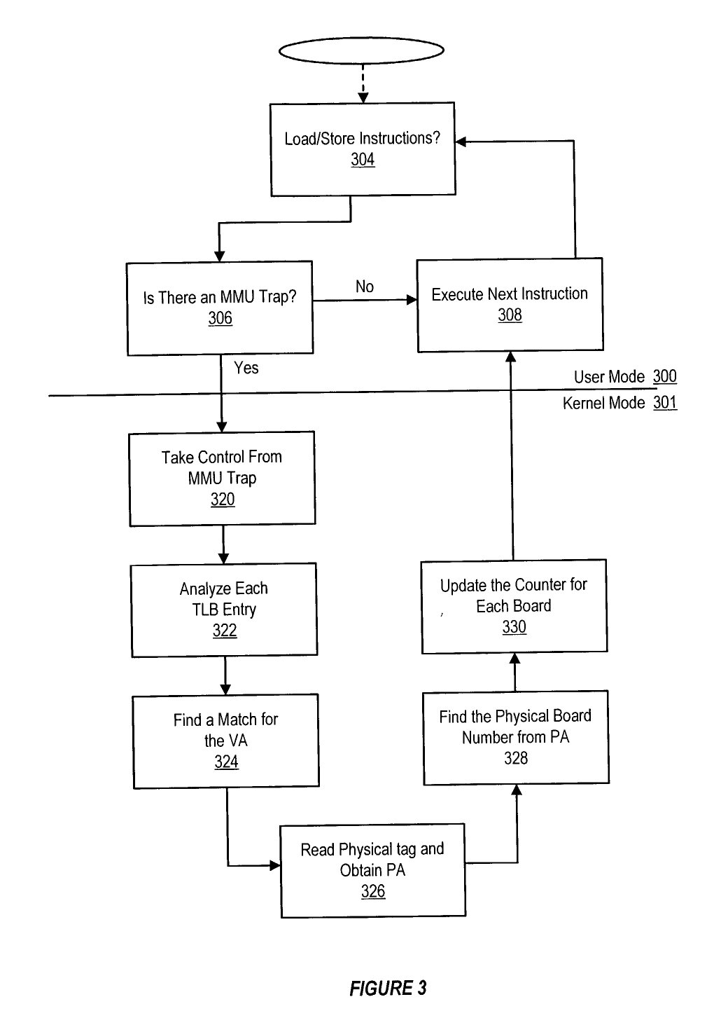

Referring to FIG. 3, a flow chart of the interaction and operation of the device driver portion 202 and the user command portion 204 of the memory statistics tool 200 is shown. The user command portion 202 of the memory statistics tool 200 executes during a user mode of execution 300 of the computer system 100. The device driver portion 202 attaches to the operating system 100 and collects statistics data during a kernel mode of operation 301.

When computer system 100 is operating in the user mode operation 300, load/store instructions are executed as indicated at step 304. (Other instructions also execute during the operation at computer system 100). When a load/store instruction is executed by a processor, a trap may occur if the instruction misses. Step 306 determines whether a memory management unit (MMU) trap occurs. If no trap occurs, then the computer system 100 executes the next instruction at step 308. Some of these instructions may again be load or store instructions as indicated at step 304.

If an MMU trap occurs as determined by step 306, then the memory statistics tool 200 starts and the tool transfers the computer system 100 to a kernel mode of operation taking control from the operating system 210 based upon the MMU trap at step 320.

The memory statistics tool 200 then sequentially reviews each translation look aside buffer (TLB) entry at step 322. When a match is found for the virtual address (VA) that caused the trap to be generated, at step 324, then the tool 200 reads the physical tag located within the translation look aside buffer to obtain the corresponding physical address of the virtual address that caused the trap to be generated at step 326. The tool 200 then determines the physical board number (i.e., the board identifier) from the physical address at step 328. Next the tool 200 updates the counter for each board at step 330 and returns to the user operation mode 300 in which the computer system 100 executes the next instruction at step 308.

The user of the memory statistics tool 200 may access a statistic array showing the frequency of memory access by a particular processor located on a particular board. Table 1 shows one example of such a statistics array. In this example there are four processors per board and five boards within the computer system 100. In this table, the identifier “B” indicates a board number and the identifier “CPU” indicates a processor on a particular board. For example, CPU1 [B3] indicates processor 1 on board number 3.

| | B0 | B1 | B2 | B3 | B4 | B5 |
|---|---|---|---|---|---|---|
| CPU0 [B0] | 39208 | 72 | 3 | 0 | 0 | 74 |
| CPU1 [B0] | 70 | 0 | 0 | 0 | 0 | 4 |
| CPU2 [B0] | 0 | 0 | 0 | 0 | 0 | 0 |
| CPU3 [B0] | 1 | 0 | 0 | 0 | 0 | 0 |
| CPU4 [B1] | 101 | 36383 | 77 | 0 | 0 | 58 |
| CPU5 [B1] | 72 | 36500 | 3 | 0 | 0 | 66 |
| CPU6 [B1] | 97 | 36481 | 3 | 0 | 0 | 77 |
| CPU7 [B1] | 0 | 0 | 0 | 0 | 0 | 0 |
| CPU8 [B2] | 78 | 0 | 36482 | 28 | 0 | 69 |
| CPU9 [B2] | 45 | 0 | 36491 | 0 | 0 | 68 |
| CPU10 [B2] | 55 | 36 | 36425 | 0 | 0 | 67 |
| CPU11 [B2] | 0 | 0 | 0 | 0 | 0 | 0 |
| CPU12 [B3] | 68 | 0 | 3 | 36616 | 28 | 63 |
| CPU13 [B3] | 59 | 0 | 3 | 36672 | 0 | 63 |
| CPU14 [B3] | 49 | 0 | 58 | 36613 | 0 | 72 |
| CPU15 [B3] | 59 | 0 | 0 | 0 | 0 | 0 |
| CPU16 [B4] | 57 | 0 | 3 | 0 | 36628 | 96 |
| CPU17 [B4] | 50 | 0 | 3 | 0 | 36742 | 69 |
| CPU18 [B4] | 37 | 0 | 3 | 55 | 36628 | 61 |
| CPU19 [B4] | 0 | 0 | 0 | 0 | 0 | 0 |
| CPU20 [B5] | 5 | 0 | 0 | 0 | 0 | 0 |
| CPU21 [B5] | 4015 | 11547 | 11562 | 11596 | 14014 | 52546 |
| CPU22 [B5] | 38 | 0 | 3 | 0 | 0 | 36716 |
| CPU23 [B5] | 34 | 0 | 3 | 0 | 54 | 36642 |

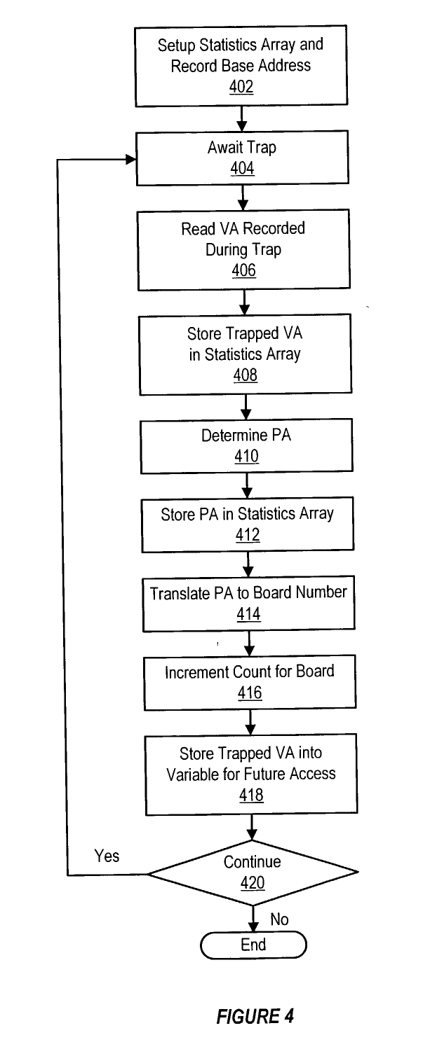

Referring to FIG. 4, a more detailed flow chart of the operation of the device driver portion 202 of the memory statistics tool 200 is shown. More specifically, when the memory statistics tool 200 is first executed, then the memory statistics tool 200 sets up a statistics array and records the base addresses of each board at setup step 402. After the setup is completed, then the tool 200 awaits a trap at step 404. When a trap occurs, then the tool 200 reads the virtual address (VA) that was recorded during the MMU trap at step 406 and then stores last trapped virtual address is the statistics array at step 408. The tool 200 then determines the physical address (PA) which corresponds to the virtual address at step 410 by searching the TLB entries. The tool then stores the physical address in the statistics array at step 412. The tool then translates the physical address to a board number at step 414. The tool then increments the counter for the board to which the trapped address corresponds at step 416. The trapped virtual address is then stored into a variable for access when another trap is detected at step 418. The tool then determines whether to continue operation or to complete execution at step 420. If execution is to continue, then the tool returns to step 404 to await another trap.

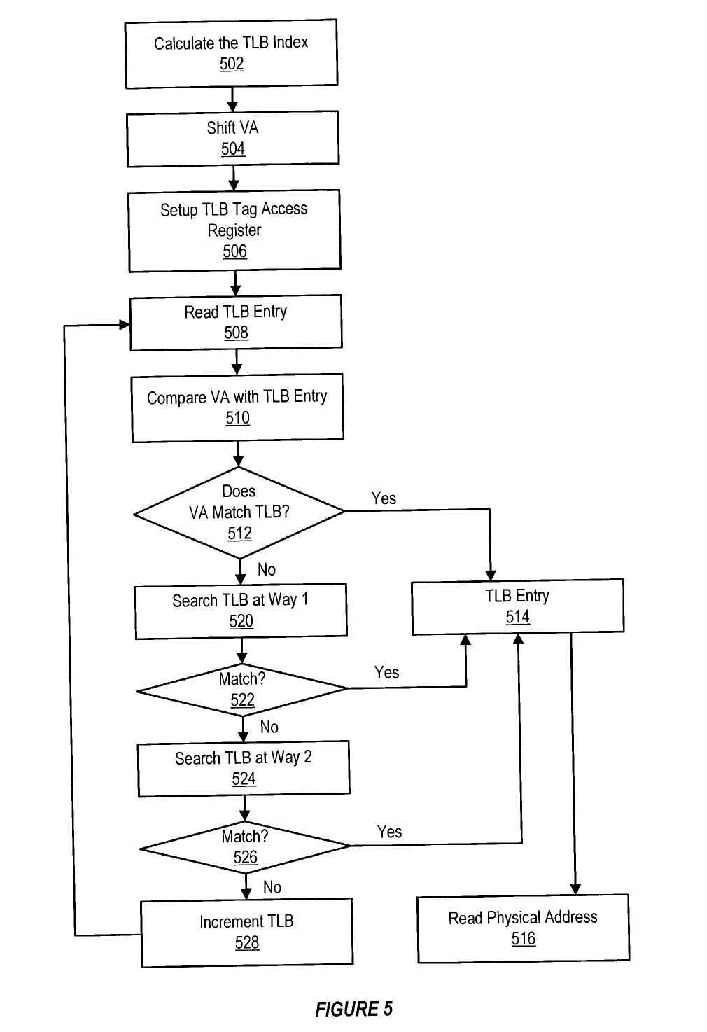

Referring to FIG. 5, a flow chart of one method for determining the physical address of step 410 is shown. More specifically, the tool 200 first calculates a translation look aside buffer (TLB) index based upon the virtual address of the trap at step 502. The index is calculated using the subset of bits in the physical address that represent the board number.

Next a TLB tag access register (not shown) is setup to read the TLB entry corresponding to the index at step 506. Next the TLB entry is read at step 508. After the TLB entry is read, the virtual address recorded in the TLB entry is compared with the trapped virtual address at step 510. If the virtual address recorded in the TLB entry matches the trapped virtual address then this is the TLB location corresponding to the virtual address of the trap. Accordingly, the TLB entry is accessed at step 514 and the physical address is read at step 516.

In the exemplative embodiment, each TLB is a 2-way TLB and each way is searched independently. Accordingly, if the trapped virtual address does not match the TLB entry in the first way, then the TLB at the next way (i.e., bank) is compared with the virtual address at step 520. If there is a match as determined by step 522, then this location is the TLB location corresponding to the virtual address of the trap. Accordingly, the TLB entry is accessed at step 514 and the physical address is read at step 516.

If the trapped virtual address does not match the TLB entry, then the TLB at the next way is searched at step 524. If there is a match as determined by step 526, then this location is the TLB location corresponding to the virtual address of the trap. Accordingly, the TLB entry is accessed at step 514 and the physical address is read at step 516.

If the trapped virtual address does not match the TLB entry of this way, then the TLB is incremented and the next TLB is searched. The computer system 100 includes multiple TLBs corresponding to each of the boards 102 of the computer system 100.

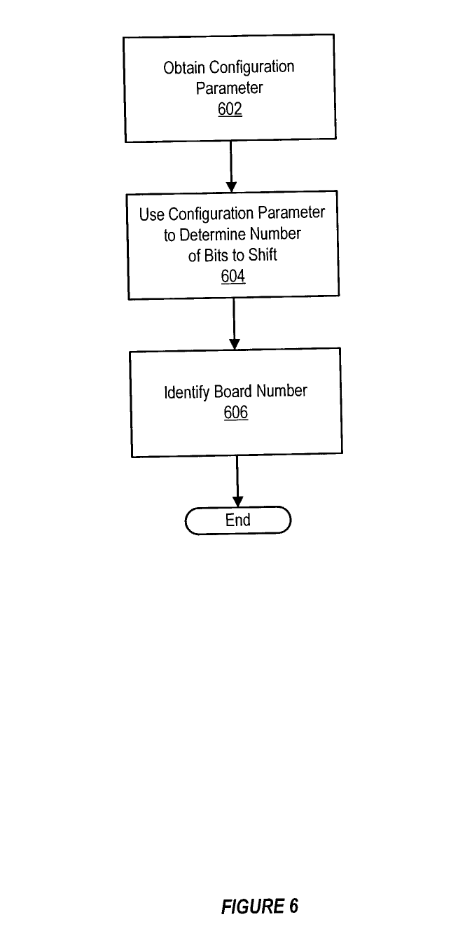

Referring to FIG. 6, a flow chart of one method for translating the physical address to a board number of step 414 is shown. More specifically, the tool 200 obtains a configuration parameter that identifies which bits of the physical address represent the board number, this configuration parameter is set in the computer system 100 at step 602. The configuration parameter is obtained using an Input Output Control (IOCTL) call for the device driver to access the user command portion of the tool 200. When the configuration parameter is obtained, then the configuration parameter is used to determine the number of bits to shift the virtual address to obtain the board number at step 604. When the determination is made, then the virtual address is shifted the specified number of bits to identify the board number at step 606.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

For example, while four boards 102 are shown, any number of boards are contemplated. Also, while examples showing two and five processors are set forth, any number of processors are contemplated.

Also for example, the above-discussed embodiments include software modules that perform certain tasks. The software modules discussed herein may include script, batch, or other executable files. The software modules may be stored on a machine-readable or computer-readable storage medium such as a disk drive. Storage devices used for storing software modules in accordance with an embodiment of the invention may be magnetic floppy disks, hard disks, or optical discs such as CD-ROMs or CD-Rs, for example. A storage device used for storing firmware or hardware modules in accordance with an embodiment of the invention may also include a semiconductor-based memory, which may be permanently, removably or remotely coupled to a microprocessor/memory system. Thus, the modules may be stored within a computer system memory to configure the computer system to perform the functions of the module. Other new and various types of computer-readable storage media may be used to store the modules discussed herein. Additionally, those skilled in the art will recognize that the separation of functionality into modules is for illustrative purposes. Alternative embodiments may merge the functionality of multiple modules into a single module or may impose an alternate decomposition of functionality of modules. For example, a software module for calling sub-modules may be decomposed so that each sub-module performs its function and passes control directly to another sub-module.

Consequently, the invention is intended to be limited only by the spirit and scope of the appended claims, giving full cognizance to equivalents in all respects.

What is claimed is:

1. A method of generating physical memory access statistics for a computer system having a non-uniform memory access architecture, the computer system including a plurality of processors located on a respective plurality of boards, the method comprising
monitoring when a memory trap occurs;
determining a physical memory access location when the memory trap occurs;
determining a frequency of physical memory accesses by the plurality of processors based upon the physical memory access locations; and
generating physical memory statistics showing the frequency of physical memory accesses by the plurality of processors for each board of the computer system.

2. The method of claim 1 wherein the determining a physical memory access location includes accessing a translation look aside buffer to match a virtual address with a physical address.

3. The method of claim 1 wherein the determining a physical memory access location includes determining a board identifier corresponding to the physical memory access location.

4. The method of claim 1 wherein
the monitoring occurs in a user mode of operation.

5. The method of claim 1 wherein the determining a frequency of physical memory accesses are determined in a kernel mode of operation.

6. The method of claim 1 wherein the generating physical memory statistics occurs in a kernel mode of operation.

7. The method of claim 1 wherein the memory trap corresponds to a virtual address and the determining a physical memory access location includes obtaining a physical address corresponding to the virtual address.

8. A tool for generating physical memory access statistics for a computer system having a non-uniform memory access architecture, the computer system including a plurality of processors located on a respective plurality of boards, the tool comprising
a user command portion, the user command portion allow a user to access the tool, the user command portion including
means for presenting the physical memory access statistics; and,
means for monitoring when a memory trap occurs; and
a device driver portion, the device driver portion including
means for determining a physical memory access location when the memory trap occurs;
means for determining a frequency of physical memory accesses by the plurality of processors based upon the physical memory access locations; and
means for generating physical memory statistics showing the frequency of physical memory accesses by the plurality of processors for each board of the computer system.

9. The tool of claim 8 wherein the means for determining a physical memory access location includes means for accessing a translation look aside buffer to match a virtual address with a physical address.

10. The tool of claim 8 wherein the means for determining a physical memory access location includes means for determining a board identifier corresponding to the physical memory access location.

11. The tool of claim 8 wherein
the means for monitoring executes in a user mode of operation.

12. The tool of claim 8 wherein the means for determining a physical memory access location and the means for determining a frequency of physical memory accesses execute in a kernel mode of operation.

13. The tool of claim 8 wherein the means for generating physical memory statistics executes in a kernel mode of operation.

14. The tool of claim 8 wherein the memory trap corresponds to a virtual address and the means for determining a physical memory access location includes means for obtaining a physical address corresponding to the virtual address.

15. An apparatus for generating physical memory access statistics for a computer system having a non-uniform memory access architecture, the computer system including a plurality of processors located on a respective plurality of boards, the apparatus comprising
a user command portion, the user command portion allow a user to access the tool, the user command portion including
instructions for presenting the physical memory access statistics; and
instructions for monitoring when a memory trap occurs; and,
a device drive portion, the device driver portion including
instructions for determining a physical memory access location when the memory trap occurs;
instructions for determining a frequency of physical memory accesses by the plurality of processors based upon the physical memory access locations; and
instructions for generating physical memory statistics showing the frequency of physical memory accesses by the plurality of processors for each board of the computer system.

16. The apparatus of claim 15 wherein the instructions for determining a physical memory access location includes instructions for accessing a translation look aside buffer to match a virtual address with a physical address.

17. The apparatus of claim 15 wherein the instructions for determining a physical memory access location includes instructions for determining a board identifier corresponding to the physical memory access location.

18. The apparatus of claim 15 wherein
the instructions for monitoring executes in a user mode of operation.

19. The apparatus of claim 15 wherein the instructions for determining a physical memory access location and the instructions for determining a frequency of physical memory accesses execute in a kernel mode of operation.

20. The apparatus of claim 15 wherein the instructions for generating physical memory statistics executes in a kernel mode of operation.

21. The apparatus of claim 15 wherein the memory trap corresponds to a virtual address and the instructions for determining a physical memory access location includes instructions for obtaining a physical address corresponding to the virtual address.
